(19) United States
(12) Patent Application Publication
(10) Pub. No.: US 2014/0373183 A1
(43) Pub. Date: Dec. 18, 2014

(54) COMPUTER AND CONTROL METHOD THEREOF

(71) Applicant: QUANTA COMPUTER INC., Tao Yuan Shien (TW)

(72) Inventors: Chi-Li LI, Taoyuan County (TW); Chun-Hao LIEN, Taipei City (TW)

(73) Assignee: QUANTA COMPUTER INC., Tao Yuan Shien (TW)

(21) Appl. No.: 14/042,770

(22) Filed: Oct. 1, 2013

(30) Foreign Application Priority Data
Jun. 17, 2013 (TW) 102121328

(51) Int. Cl. G06F 21/81

(52) U.S. Cl. CPC G06F 21/81
USPC 726/34

(57) ABSTRACT

A computer and a control method thereof are provided. The computer includes a power button, a flash read-only memory (ROM), a processor, a near field communication (NFC) module, a chipset, and a coprocessor. The flash ROM stores a power button protection state for the power button. The chipset is coupled to the processor and the flash ROM. The coprocessor is coupled to the power button, the NFC module, and the chipset. The coprocessor verifies whether a current user identification (UID) of a NFC card equals a default user identification (UID) after the NFC module generates an interrupt request (IRQ). The coprocessor changes the power button protection state when the current UID equals the default UID.

This application claims the benefit of Taiwan application Serial No. 102121328, filed Jun. 17, 2013, the subject matter of which is incorporated herein by reference.

### BACKGROUND OF THE INVENTION

1. Field of the Invention

The invention relates in general to an electronic device, and more particularly to a computer and a control method thereof.

2. Description of the Related Art

While the computer and information technology progress, computers have been adopted and applied in various fields. The conventional booting process of computers starts by pressing the power button of the computer manually by a user. When the power button is pressed, the computer firstly loads a basic input/output system (BIOS) to execute a number of operations, such as power-on self-test (POST), hardware detection, installing device drivers, loading an operating system (OS) and so on.

It is noted that the booting of the conventional computer can be activated by any user pressing the power button manually regardless of whether the user is authorized or not. In this way, the information security may be affected seriously. Thus, it becomes an important topic concerning how to enhance the convenience for the user and information security in usage of computers.

### SUMMARY OF THE INVENTION

The invention is directed to a computer and a control method thereof, which can lock or unlock a power button of a computer by using a near field communication card to readily enable or disable a power button protection state. In this manner, both the convenience and information security in usage of the computer can be enhanced.

According to an aspect of the invention, a computer is provided. The computer includes a power button, a flash read-only memory (ROM), a processor, a near field communication (NFC) module, a chipset, and a coprocessor. The flash ROM stores a power button protection state for the power button. The chipset is coupled to the processor and the flash ROM. The coprocessor is coupled to the power button, the NFC module and the chipset. The coprocessor verifies whether a current user identification (UID) of a NFC card equals a default user identification (UID) after the NFC module generates an interrupt request (IRQ). The coprocessor changes the power button protection state when the current UID equals the default UID.

According to another aspect of the invention, a control method for a computer is provided. The control method for a computer includes the following. A determination is made by a coprocessor whether a near field communication (NFC) module generates an interrupt request (IRQ). A current user identification (UID) is read from a NFC card if the IRQ is generated. It is verified whether the current UID equals a default UID. A power button protection state is changed when the current UID equals the default UID.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram illustrating a computer and a near field communication card according to a first embodiment.

FIG. 2 illustrates a coprocessor and a near field communication card.

FIG. 3 is a flowchart for a control method for a computer according to the first embodiment.

FIG. 4 is a detailed flowchart for step 32.

FIG. 5 is a flowchart for a control method for a computer according to a second embodiment.

### DETAILED DESCRIPTION OF THE INVENTION

### First Embodiment

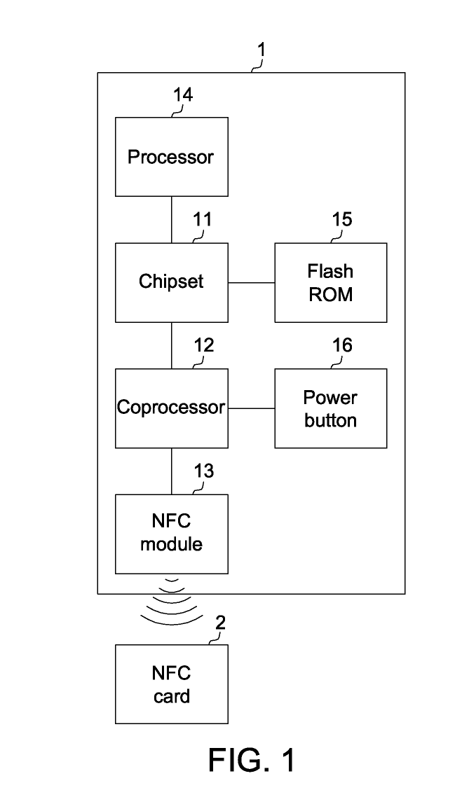

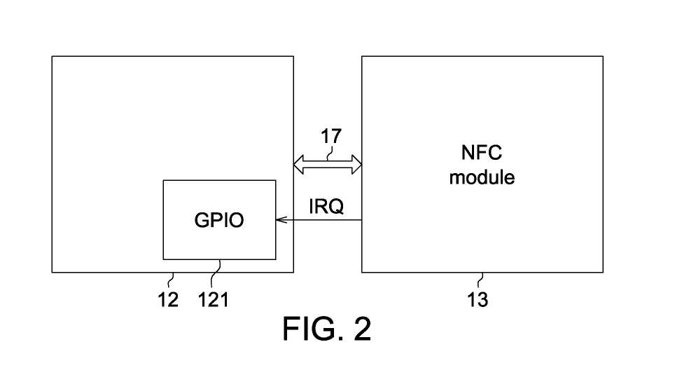

Referring to FIGS. 1 and 2, FIG. 1 is a block diagram illustrating a computer and a near field communication card according to a first embodiment; and FIG. 2 illustrates a coprocessor and a near field communication card. In FIG. 1, a computer 1, for example, is a desktop computer, tablet computer, notebook computer, all-in-one (AIO) computer, or ultrabook. The computer 1 includes a chipset 11, a coprocessor 12, a near field communication (NFC) module 13, a processor 14, a flash read-only memory (ROM) 15, and a power button 16. The coprocessor 12, for example, is an embedded controller (EC). The flash ROM 15 stores a power button protection state for the power button 16, and the power button protection state may be in an enabled state or an disabled state. When the power button protection state is enabled, the power button 16 is locked. In this case, the processor 14 cannot execute the process of a basic input/output system (BIOS) for the computer even if a user presses the power button 16. Conversely, when the power button protection state is disabled, the power button 16 is unlocked. In this case, when the user presses the power button 16, the processor 14 executes the process of the BIOS. The chipset 11 is coupled to the processor 14 and the flash ROM 15; and the coprocessor 12 is coupled to the power button 16, the NFC module 13, and the chipset 11.

In addition, the coprocessor 12 is operative to verify whether a current user identification (UID) of a NFC card 2 equals a default user identification (UID) after the NFC module 13 generates an interrupt request (IRQ). Meanwhile, the computer 1 is in soft-off state S5. According to Advanced Configuration and Power Interface (ACPI), the soft-off state S5 indicates that the computer 1 has standby power for its components. The standby power, for example, is obtained by using an adapter connected to the electric supply or a battery. The soft-off state S5 is different from mechanical-off state G3. According to ACPI, the mechanical-off state G3 indicates that the computer 1 has no standby power for its components. In other words, the computer 1 cannot obtain any standby power from the electric supply or battery in the mechanical-off state G3. In this situation, the computer 1 may be equipped without battery and not connected to the electric supply through the adapter.

When the current UID equals the default UID, the coprocessor 12 changes the power button protection state. For instance, if the power button protection state is in the disabled state originally, the coprocessor 12 changes the power button protection state from the disabled state to the enabled state when the current UID equals the default UID. Conversely, if the power button protection state is in the enabled state originally, the coprocessor 12 changes the power button protection state from the enabled state to the disabled state when the current UID equals the default UID. In this manner, the user can only put the NFC card 2 near the NFC module 13 to change the power button protection state automatically.

The coprocessor 12 further includes a general purpose input/output (GPIO) pin 121 to receive the IRQ. When the NFC card 2 is placed near the NFC module 13, the NFC module 13 generates the IRQ. After the GPIO pin 121 receives the IRQ, the coprocessor 12 verifies whether the current UID equals the default UID. The coprocessor 12 can communicate with the NFC module 13 through a bus 17, for example, a system management bus (SMBus) or an inter-integrated circuit (I2C). The bus 17 may further include a clock signal line and a data signal line.

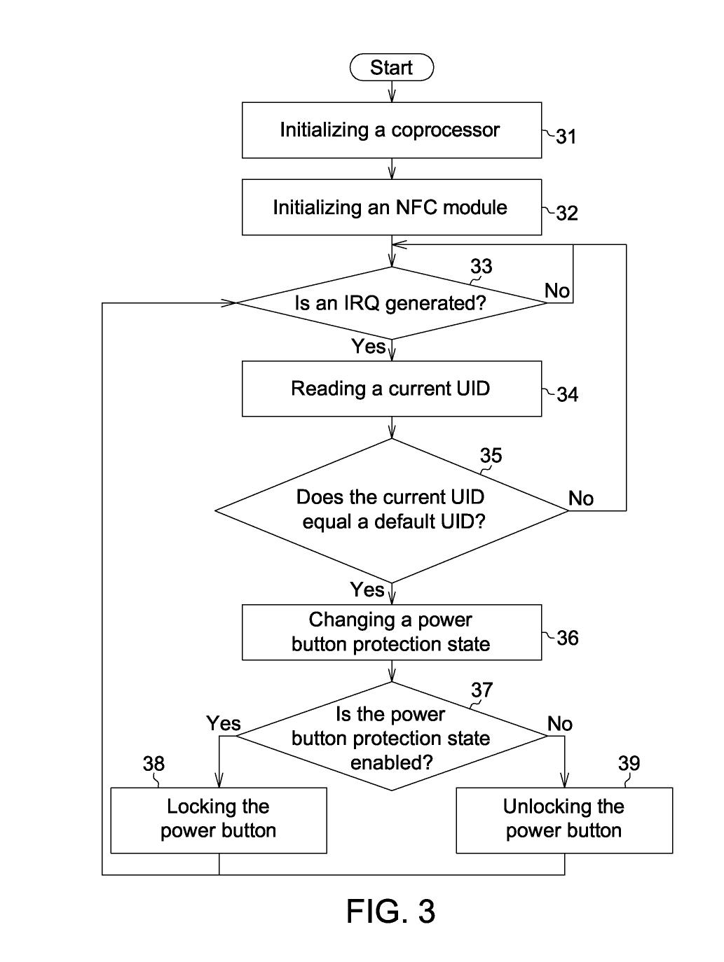

Referring to FIGS. 1 and 3, FIG. 3 is a flowchart for a control method for a computer according to the first embodiment. The control method can be applied to the computer 1, and executed in the computer 1 in the soft-off state S5. The control method of the computer 1 includes the following steps. First, the coprocessor 12 is initialized, as shown in step 31. Then, the NFC module 13 is initialized, as shown in step 32. As shown in step 33, the coprocessor 12 determines whether the NFC module 13 generates an interrupt request (IRQ). If the NFC module 13 does not generate the IRQ, step 33 is repeated. Conversely, if the NFC module 13 generates the IRQ, step 34 is executed. As shown in step 34, the NFC module 13 reads the current UID from the NFC card 2. Afterwards, the coprocessor 12 verifies whether the current UID equals a default UID, as shown in step 35. If the current UID does not equal the default UID, step 33 is executed. Conversely, if the current UID equals the default UID, step 36 is executed. As shown in step 36, the coprocessor 12 changes the power button protection state. If the power button protection state is in the disabled state originally, the coprocessor 12 changes the power button protection state from the disabled state to the enabled state. Conversely, if the power button protection state is in the enabled state originally, the coprocessor 12 changes the power button protection state from the enabled state to the disabled state.

Following that, the coprocessor 12 checks whether the power button protection state is enabled, as shown in step 37. If the power button protection state is in the enabled state, step 38 is executed. As shown in step 38, the coprocessor 12 locks the power button 16. After the power button 16 is locked, the booting process of BIOS cannot be executed even if a user presses the power button 16. In addition, the coprocessor 12, after the power button 16 is locked, goes on checking whether the NFC module 13 generates an IRQ. Conversely, if the power button protection state is in the disabled state, step 39 is executed. As shown in step 39, the coprocessor 12 unlocks the power button 16. After the power button 16 is unlocked, the booting process of BIOS is to be executed if the user presses the power button 16. In addition, the coprocessor 12, after the power button 16 is unlocked, goes on checking whether the NFC module 13 generates an IRQ. In the above manner, the information security in usage for the computer 1 can be effectively enhanced by locking the power button 16 by the user with the NFC card 2, thus preventing the computer 1 being operated undesirably by unauthorized users. Further, the power button 16 can be locked or unlocked automatically if the user puts the NFC card 2 near the NFC module 13, which brings much more convenience in usage for the computer 1 in this regard.

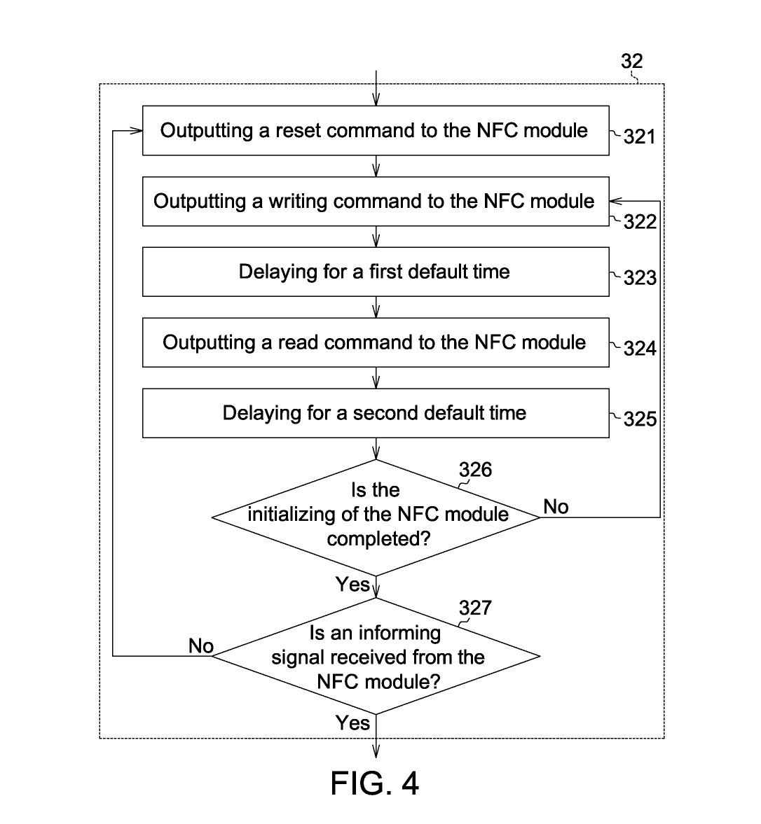

Referring to FIGS. 1, 3, and 4, FIG. 4 is a detailed flowchart for step 32. Step 32, as above, may include steps 321 to 327. First, as shown in step 321, the coprocessor 12 outputs a reset command to the NFC module 13. As shown in step 322, the coprocessor 12 then outputs a writing command to the NFC module 13. After that, as shown in step 323, delaying for a first default time is made to ensure that the writing command is outputted to the NFC module 13. As shown in step 324, the coprocessor 12 then outputs a read command to the NFC module 13. In step 325, delaying for a second default time is made to ensure that the read command is outputted to the NFC module 13. The first default time and second default time can be changed according to the practical architecture and specification of the computer 1. Following that, in step 326, the coprocessor 12 checks whether the initializing of the NFC module is completed. If the initializing of the NFC module is not completed, step 322 is executed again. Conversely, if the initializing of the NFC module is completed, step 327 is performed. As shown in step 327, the coprocessor 12 checks whether an informing signal is received from the NFC module 13 if the initializing of the NFC module is completed. If the coprocessor 12 does not receive any informing signal from the NFC module 13, step 321 is executed again. Conversely, the coprocessor 12 receives an informing signal from the NFC module 13, step 33, as above mentioned, is executed.

### Second Embodiment

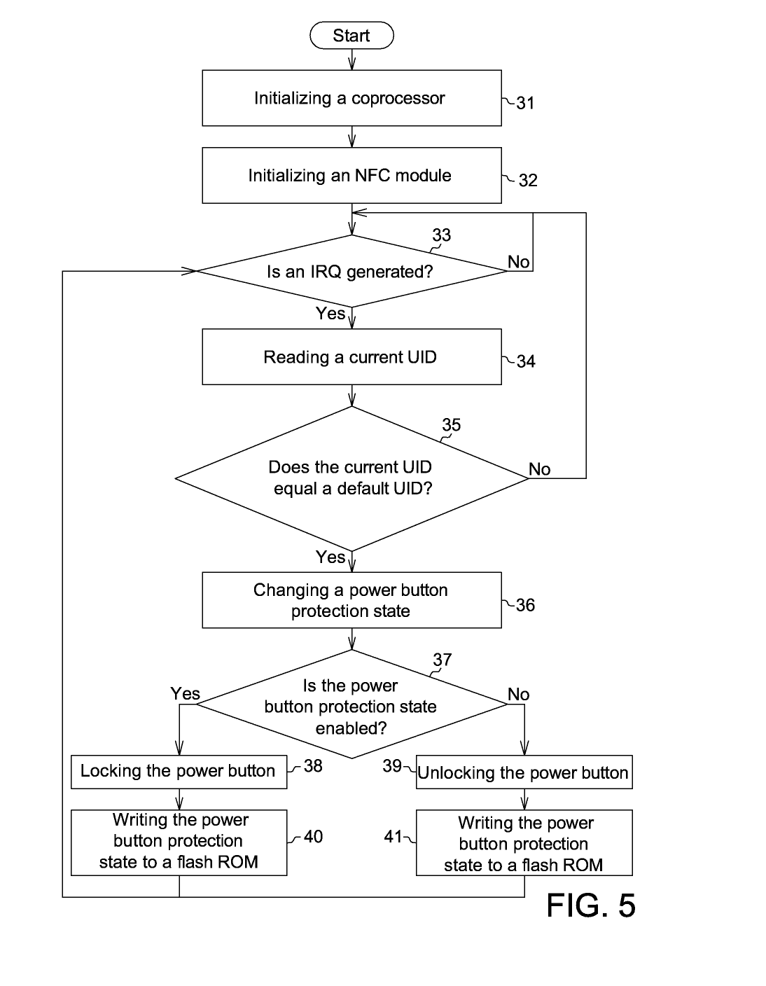

Referring to FIGS. 1, 3, and 5, FIG. 5 is a flowchart for a control method for a computer according to a second embodiment. The second embodiment mainly differs from the first embodiment in that the second embodiment further includes steps 40 and 41 in addition to steps 31 to 39. In the control method of the second embodiment, after the power button 16 is locked, the power button protection state is written to the flash ROM 15, as shown in step 40. The flash ROM 15 stores the power button protection state in the enabled state. Similarly, after the power button 16 is unlocked, the power button protection state is written to the flash ROM 15, as shown in step 41. The flash ROM 15 stores the power button protection state in the disabled state.

In the second embodiment, the mechanism for the power button protection state remains working properly even if the computer 1 enters to the mechanical-off state G3. This is because in the second embodiment the power button protection state is stored in the flash ROM 15, and the power button protection state will not lose even if the flash ROM 15 is powered off. When step 40 is completed, the power button protection state stays in the enabled state even if the battery or power supply is removed. Accordingly, this approach can further prevent the mechanism for the power button protection state from failing in case the unauthorized user removes the battery or power supply, thus enhancing the information security.

In the above computer and the control method thereof, the power button is locked by using the NFC card, preventing the authorized user from operating the computer. In addition, putting the NFC card near the NFC module by the user can lead to the power button being locked or unlocked automatically, which enhances the convenience of operating the computer.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A computer, comprising:
a power button;
a flash read-only memory (ROM) for storing a power button protection state for the power button;
a processor;
a near field communication (NFC) module;
a chipset, coupled to the processor and the flash ROM; and
a coprocessor, coupled to the power button, the NFC module and the chipset, wherein the coprocessor is operative to verify whether a current user identification (UID) of a NFC card equals a default user identification (UID) after the NFC module generates an interrupt request (IRQ), and the coprocessor is operative to change the power button protection state when the current UID equals the default UID.

2. The computer according to claim 1, wherein the coprocessor is operative to change the power button protection state from a disabled state to an enabled state when the current UID equals the default UID.

3. The computer according to claim 1, wherein the coprocessor is operative to change the power button protection state from an enabled state to a disabled state when the current UID equals the default UID.

4. The computer according to claim 1, wherein the coprocessor is operative to read the current UID from the NFC card after the NFC module generates the IRQ.

5. The computer according to claim 1, wherein the coprocessor is further operative to check whether the power button protection state is enabled, and to lock the power button when the power button protection state is enabled.

6. The computer according to claim 5, wherein the power button protection state is written to the flash ROM when the power button is locked.

7. The computer according to claim 1, wherein the coprocessor is further operative to check whether the power button protection state is enabled, and to unlock the power button when the power button protection state is not enabled.

8. The computer according to claim 7, wherein the power button protection state is written to the flash ROM when the power button is unlocked.

9. The computer according to claim 1, wherein the coprocessor comprises a general purpose input/output (GPIO) pin to receive the IRQ.

10. A control method for a computer, the method comprising:
determining, by a coprocessor, whether a near field communication (NFC) module generates an interrupt request (IRQ);
reading a current user identification (UID) from a NFC card if the IRQ is generated;
verifying whether the current UID equals a default UID; and
changing a power button protection state when the current UID equals the default UID.

11. The control method according to claim 10, wherein the power button protection state is changed from a disabled state to an enabled state when the current UID equals the default UID.

12. The control method according to claim 10, wherein the power button protection state is changed from an enabled state to a disabled state when the current UID equals the default UID.

13. The control method according to claim 10, further comprising:
checking whether the power button protection state is enabled;
locking a power button when the power button protection state is enabled; and
unlocking the power button when the power button protection state is not enabled.

14. The control method according to claim 13, wherein the power button protection state is written to a flash ROM when the power button is locked.

15. The control method according to claim 13, wherein the power button protection state is written to a flash ROM when the power button is unlocked.

16. The control method according to claim 10, further comprising:
initializing the coprocessor; and
initializing the NFC module.

17. The control method according to claim 16, wherein the step of initializing the NFC module comprises:
outputting a writing command to the NFC module after outputting a reset command to the NFC module;
delaying for a first default time after the writing command is outputted to the NFC module;
outputting a read command to the NFC module after the delaying for the first default time; and
delaying for a second default time after the read command is outputted to the NFC module.

18. The control method according to claim 17, wherein the step of initializing the NFC module further comprises:
checking whether the initializing of the NFC module is completed; and
checking whether an informing signal is received from the NFC module if the initializing of the NFC module is completed.
